(19) United States
(12) Patent Application Publication
(10) Pub. No.: US 2015/0039361 A1
(43) Pub. Date: Feb. 5, 2015

(54) Techniques for Managing Snow Removal Equipment Leveraging Social Media

(71) Applicant: International Business Machines Corporation, Armonk, NY (US)

(72) Inventors: Scott R. Crowther, LaGrangeville, NY (US); Grant D. Miller, Arvada, CO (US); Nader M. Nassar, Yorktown Heights, NY (US); Tamer M. Nassar, Bethel, CT (US)

(73) Assignee: International Business Machines Corporation, Armonk, NY (US)

(21) Appl. No.: 13/958,953

(22) Filed: Aug. 5, 2013

(51) Int. Cl. G06Q 10/06; G06Q 50/00

(52) U.S. Cl. CPC G06Q 10/0631; G06Q 50/01
USPC 705/7.12

(57) ABSTRACT

Techniques that leverage social media to proactively respond to inclement weather conditions such as snow that affect road conditions and, for example, coordinate snow removal from the roads are provided. In one aspect, a method for sharing road condition information is provided. The method includes the following steps. Data is collected from vehicles related to road conditions at various locations. The data is stored in an off-vehicle system. The data is processed to determine what type of maintenance activity is needed based on the road conditions. The maintenance activity and the locations are provided to dispatchers to enable routing of municipal vehicles to the locations to address the road conditions. A system for sharing road conditions is also provided.

### FIELD OF THE INVENTION

The present invention relates to addressing adverse road conditions and more particularly, to techniques that leverage social media to proactively respond to inclement weather conditions such as snow that affect road conditions and, for example, coordinate snow removal from the roads.

### BACKGROUND OF THE INVENTION

In today's changing climate, snow removal plans are fast falling out of date. In late 2011, Alaska received an unprecedented amount of snowfall. Conversely, in early 2012, the Northeastern United States saw the least amount of snowfall in years. Municipal departments need improved ways of handling today's unexpected weather in real-time.

For instance, most municipalities employ pre-designed routing plans doctored by snow removal companies in conjunction with some feedback from the township which provide priorities to main streets and highways. Thus, snow removal routes are pre-calculated and static which does not address any arbitrary sudden accumulation. When static routes are used, sand, salt, or other materials deployed for traction inevitably end up getting wasted in locations where they are dispensed but are not needed. This results in wasted resources both due to the overuse of materials and the time spent in areas not needing attention.

There is a glimpse of social feedback sponsored by radio stations where listeners can call in and report a traffic jam, road incidents, accidents, etc. which then gets broadcasted passively through the airwave. In the same context, new mobile apps and IP-powered global positioning system (GPS) devices also have social feedback related to traffic jam and road accidents in near real time.

These solutions may alert the driver to avoid a certain road, or alert the law enforcement agencies to take certain actions but only in a passive context, i.e., it doesn't address the removal of the bad road conditions due, for example, to severe weather or any sudden changes in the road conditions that require immediate attention. For instance, when a radio station alerts its listeners to avoid a certain street due to a severe weather condition, the message is geared toward the drivers who are listening to the station at that particular time, but it's not actively doing anything to assist managing or addressing this road condition. By the same token, mobile apps and GPS feedback fall into the same category of passiveness and driver-targeted alerts.

Additionally, using conventional processes local governments can only plan for normal weather patterns. If a large storm or unexpected event occurs, they are often without enough equipment and/or resources to handle the management of roads efficiently since municipalities will have to send equipment to cover all roads and bridges, and they do not have up-to-date information about which areas are the worst and require the most immediate attention.

Accordingly, proactive techniques for accurately and efficiently addressing adverse road conditions due for example to inclement weather, such as snow, would be desirable.

### SUMMARY OF THE INVENTION

The present invention provides techniques that leverage social media to proactively respond to inclement weather conditions such as snow that affect road conditions and, for example, coordinate snow removal from the roads. In one aspect of the invention, a method for sharing road condition information is provided. The method includes the following steps. Data related to road conditions at various locations is collected from vehicles. The data is stored in an off-vehicle system. The data is processed to determine what type of maintenance activity is needed based on the road conditions. The maintenance activity and the locations are provided to dispatchers to enable routing of municipal vehicles to the locations to address the road conditions.

In another aspect of the invention, a system for sharing road condition information is provided. The system includes a validation engine configured to i) collect data related to road conditions at various locations from vehicles and ii) process the data to determine what type of maintenance activity is needed based on the road conditions; a database configured to store the data; and a notification engine configured to provide the maintenance activity and the locations to dispatchers to enable routing of municipal vehicles to the locations to address the road conditions.

A more complete understanding of the present invention, as well as further features and advantages of the present invention, will be obtained by reference to the following detailed description and drawings.

### BRIEF DESCRIPTION OF THE DRAWINGS

FIG. 1 is a schematic diagram illustrating an overall concept of the techniques provided herein for leveraging social media to collect road condition and location data from cars and municipal vehicles which can then be used to monitor road conditions in real time and permit proactive response to adverse road conditions according to an embodiment of the present invention;

FIG. 2 is a schematic diagram illustrating how the techniques provided herein can acquire road condition data from vehicle occupants (e.g., via social media) according to an embodiment of the present invention;

FIG. 3 is a diagram illustrating an exemplary methodology for sharing road condition information according to an embodiment of the present invention;

FIG. 4 is a schematic diagram illustrating an exemplary implementation of the techniques provided herein for sharing road condition information using a weather sentry system and social media according to an embodiment of the present invention;

FIG. 5 is a diagram illustrating exemplary road condition data collected (e.g., by the weather sentry system) from a vehicle according to an embodiment of the present invention; and

FIG. 6 is a diagram illustrating an exemplary apparatus for performing one or more of the methodologies presented herein according to an embodiment of the present invention.

### DETAILED DESCRIPTION OF PREFERRED EMBODIMENTS

Provided herein are techniques that leverage social media (such as mobile apps, social networking sites, etc.) to collect road condition and location data from cars (and other privately operated vehicles) and municipal vehicles (such as weather management equipment, e.g., snow plows, road construction vehicles, etc.) which can then be used to monitor road conditions in real time and permit proactive response to adverse road conditions (such as snow removal from those roads that are in need of it). The data collected can also be used to predict future road conditions at given locations, thereby allowing for a better allocation of resources for dealing with future weather events.

As shown in FIG. 1, the techniques provided herein revolve around enabling cars (and other privately operated vehicles) and/or weather management equipment (e.g., snow plows, road construction vehicles, etc.) to automatically collect and send information to a central system (labeled “Weather Sentry System”) relaying road conditions (slipping (ABS), differential, temperature, etc.) and location (GPS). Specifically, many modern vehicles are equipped with IP-powered global positioning system (GPS) devices, such as OnStar® and numerous other commercially-available systems, which permit data to be collected from vehicles, such as location data, vehicle performance/operating data, etc. This data collected by the vehicles/equipment can be sent to the Weather Sentry System via a social media outlet.

Further, most modern vehicles have central computer systems which control and/or monitor vehicle operation. For instance, the computer system(s) in modern vehicles monitor data obtained from numerous (e.g., oxygen, temperature, engine) sensors, as well as control the anti-lock braking (ABS), air bag, etc. systems in the vehicle.

In accordance with the present techniques, these existing systems are used to obtain road condition data automatically from vehicles. Thus, for instance, when a vehicle(s) slip on an icy road, their on-board computers via the ABS system in the vehicle will register the event (since slipping on ice will likely cause the vehicles ABS system to engage). This can be reported via the IP-powered GPS system, along with the GPS coordinates (i.e., location) of the vehicle, to the present weather sentry system. See FIG. 1. It is preferable that no other data besides the road condition and location data is transmitted, so as to preserve privacy of the vehicle occupants owners/operators. It is also preferable that the weather management equipment be similarly equipped with these data gathering and reporting capabilities. See FIG. 1.

According to an exemplary embodiment, once a threshold number of incidents (e.g., icy road conditions) are reported, then it is determined that an adverse road condition exists, and the weather sentry system will initiate the dispatch of the weather management equipment to the location. See FIG. 1. The threshold ensures that an actual adverse road condition exists. For instance, when icy conditions are present on a road, it is likely that multiple vehicles would report this condition. A single vehicle reporting an incident (over a given time period) might be due to a situation specific to that vehicle (such as a faulty reading due to a faulty sensor) and not a genuine road condition. The threshold employed can be varied depending on the amount of traffic the road sees. The time of day might also factor into the determination. For instance, a highway or freeway would likely have more traffic than a local road. Thus, setting the threshold number of incidents reported (from private or municipal vehicles) to be greater for highways/freeways than for local roads makes sense, since a fewer number of vehicles means a correspondingly lower number of incident reports. Further, for a given roadway, such as a highway or freeway for example, the amount of traffic might vary depending on the time of day, e.g., traffic is expected to be heaviest during rush hours, and lighter during nights and weekends. Thus, the threshold number of incident reports for a given road may also be varied depending on the time of day. Accordingly, it is thus also necessary to have, in addition to the road condition and location data, a timestamp on the incident reports.

By way of example only, a threshold number of incident reports of greater than or equal to 5 reports per hour long period for a local road and greater than or equal to about 10 reports per hour long period for a highway/freeway can be employed, with roads of sizes in between these ranges scaled accordingly. Further, it is notable that multiple incident reports may come from the same vehicle. For instance, as will be described in detail below, occupants of a vehicle might also (e.g., via social media) report poor road conditions to the weather sentry system. Thus, these reports might be submitted in addition to the reports automatically reported by the vehicle.

According to an exemplary embodiment, based on an alert from the weather sentry system (e.g., an electronic alert/message), a regional manager would dispatch snow management equipment to areas based on the need reported by the data collection system. Equipment on way to a location or at a location could be rerouted to areas needing assistance. Areas that do not have enough equipment could get support. Based on the conditions reported, the snow management agency would know what types of services are needed (e.g., plowing for removal or sand/salt for traction in icy conditions) and deploy them appropriately.

As highlighted above, occupants (e.g., passengers in cars) can post road information into the system using a mobile device app or a GPS based application. This would also be used by the system as described above. So, for instance, if a vehicle passes a stretch of road that has icy conditions, the passenger in the vehicle can use his/her smart phone to access an app that permits the passenger to transmit data to the system alerting the system of the icy road conditions. Most mobile phones have GPS capabilities to register location of the user when making the report. As will be described in detail below, the weather sentry system is preferably configured to process these social feeds and provide correct actions based on these feeds (e.g., validation, updating, communicating the action item, communicating back to the social platform, and resetting the request for this particular route), such that municipal equipment can be deployed and the correct action can be undertaken to deal with the conditions. Further, the weather sentry system is preferably further configured, once action has been taken and the road condition has been addressed, to update the social media outlets about the current (enhanced) road conditions.

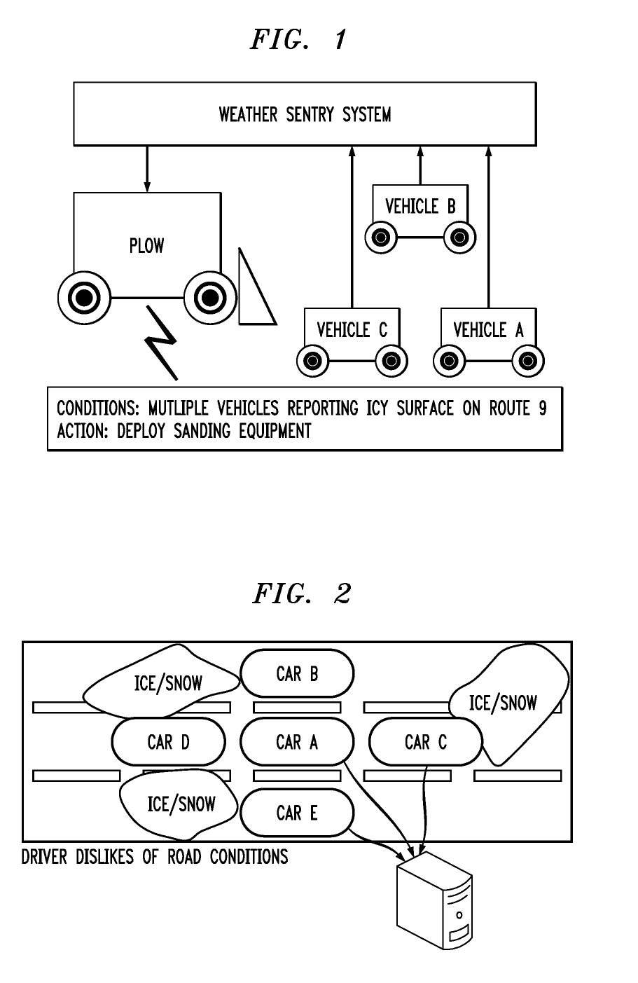

According to an exemplary embodiment, by way of a mobile app, or a social media site such as Facebook (accessed, e.g., using a mobile smart phone) a vehicle occupant can tag the road at that particular location with a geo-located update, which then would be propagated to the system with location and condition information. By way of example only, when a vehicle occupant uses a mobile app or a social media site to tag a road/road condition, a message is sent to the weather sentry system via the social media outlet and the geolocation tagging is then aggregated in the system. As multiple driver reportings of poor conditions for that location grow in number (e.g., to above the threshold number of incident reports—see above), the state and local governments could be alerted to an area needing infrastructure maintenance. Likewise, geolocation and time related reports could alert authorities to poor road conditions such as traffic jams, or worsening road conditions due to weather. See, for example, FIG. 2.

As shown in FIG. 2, cars A-E are on a road in the proximity of icy/snow conditions. The occupants in cars A, C, and E make incident reports to the system (e.g., social media, such as a mobile app designed for the system). These incident reports are received, logged, and stored by the weather sentry system server(s). If the incident reports meet or exceed a threshold number, then (as per FIG. 1) the system notifies a regional manager to take action, e.g., to dispatch municipal vehicles to those locations.

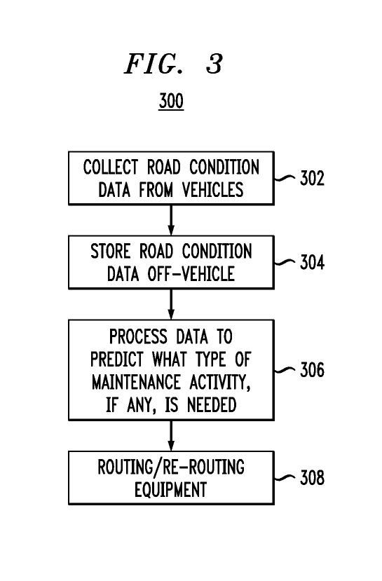

FIG. 3 is a diagram illustrating exemplary methodology 300 for sharing road condition information. In the example shown in FIG. 3, methodology 300 is described in the context of managing snow removal. However, methodology 300 is generally applicable to sharing data regarding any kind of road condition, including, but not limited to, road conditions due to inclement weather (e.g., snow, ice, flooding, etc.), traffic conditions, road conditions due to construction, road conditions due to an accident, etc.

In step 302, the weather sentry system collects road condition data from vehicles on the road. As provided above, this road condition data can be collected from cars (and other privately operated vehicles) and/or municipal vehicles (such as weather management equipment, e.g., snow plows, road construction vehicles, etc.). Further, as provided above, according to the present techniques, the road condition data can be collected automatically from the vehicles (e.g., by way of vehicles equipped with IP-powered GPS system) and/or from reports submitted by occupants of the vehicles.

In the context of snow removal, the data collected in step 102 can relate to icy/snow covered road conditions. As described above, vehicles can automatically report when ABS systems are engaged (which is assumed to be in response to slick road conditions), data obtained from sensors such as temperature sensors (which can report outside temperatures and whether or not it is below freezing), etc.

With regard to the data collected automatically by the vehicles, this data can be retrieved at periodic intervals and/or whenever a certain trigger event(s) occurs. For instance, as provided above, a vehicle's on board computer can monitor outside temperatures (via temperature sensors), when the vehicle's ABS system is activated (e.g., due to slippery road conditions), etc. This data is stored in the vehicle's computer. The weather sentry system can periodically retrieve this data from the vehicles, e.g., once every from about 5 minutes to about 30 minutes. In the case of temperature data for instance, this will allow a profile to be built of temperature based on time and location. However, it may also be desirable to configure the vehicle's computer system to automatically transmit data to the weather sentry system whenever a trigger event occurs—such as whenever the ABS system is activated. Of course, this data could also be compiled and stored by the vehicle's computer and transmitted at periodic intervals as described above.

In step 304, the road condition data collected in step 302 is stored by an off-vehicle system, such as the weather sentry system depicted in FIGS. 1 and 2. In step 306, the data collected in step 304 is processed and predictions are made as to what type of maintenance activity is needed, if any.

First, as provided above, a predetermined threshold of incident reports might be set. In that case, the first determination to be made is whether or not the threshold number of reports for a location has been met or exceeded. Only if the threshold has been met or exceeded is action taken. According to an exemplary embodiment, a threshold (number of reportings) is set for a particular location(s), wherein each location corresponds to a particular sector/segment of road. For instance, roads/highways may be divided into sectors, such as today, where roads are divided by mile markers (in the U.S.). While reports from vehicles between, e.g., mile marker A and B, will not take place in the exact same geo point, the reportings are relative to that same stretch/segment of road. So if a given threshold number of reportings is set for a particular location—in this case a particular sector/segment of road, then reports from vehicles with geo points along that sector/segment of road will count towards meeting that threshold.

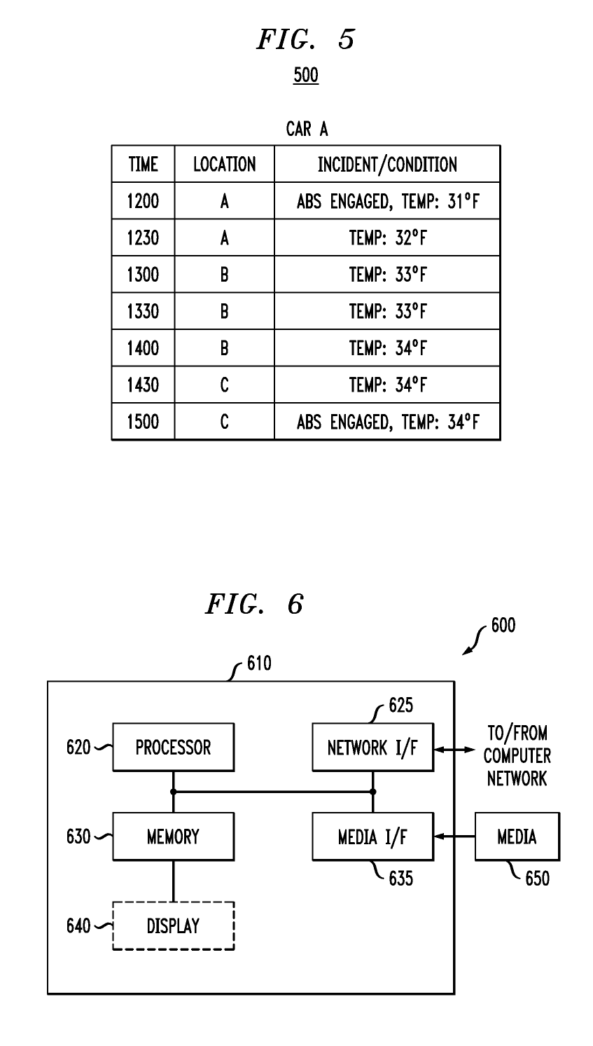

This simple example may be used to process the data: say for instance that multiple vehicles are reporting slippery road conditions at a particular location (e.g., along a particular sector/segment of road). Those vehicles are also reporting temperatures (at that location) which are below freezing. The weather sentry system can conclude, based on this data, that there is likely a slippery road condition at that location due to ice/snow. Say for instance that another time and location there are multiple vehicles reporting slippery road conditions, but the vehicles are reporting temperatures that are well above freezing. The weather sentry system can deduce that the slippery road conditions are due to something other than snow/ice. This scenario is further depicted/described in conjunction with the description of FIG. 5, below.

This example assumes that the data provided does not explicitly provide the cause of the slippery road conditions. However, as provided above, when the occupants of a vehicle send road condition data they may be able to tag a road as icy, unplowed, etc.

Next, in step 308, based on the processed data and associated predictions, equipment can be efficiently routed/re-routed to areas needing attention. Using the above example, based on the multiple vehicles reporting both slippery road conditions and temperatures below freezing at a particular location, then it is assumed that the road conditions in that area are not being adequately addressed. Thus, snow removal and/or ice treatment municipal equipment can be routed to that area. This might involve re-routing equipment from other areas. For instance, there might be equipment present at locations where no slippery road conditions are being reported. At least some of that equipment could be re-routed to the area(s) needing attention.

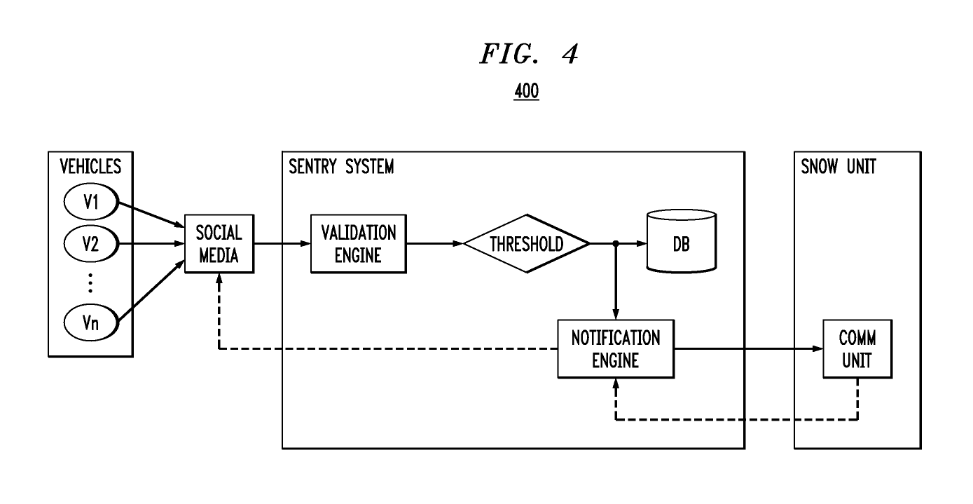

FIG. 4 is a schematic diagram illustrating an exemplary embodiment of the present techniques employing a weather sentry system as described above. As shown in FIG. 4, this example includes three components: 1. a social platform which could be represented via a variety of social outlets for instance, a mobile app, social media application/portal, etc., 2. an analytics engine of the weather sentry system which reads the social feeds and updates a response layer of the weather sentry system with the correct actions, and 3. an end unit/municipal equipment connected to the Admin portal (e.g., either manually thru a traditional communication system like a radio or a cell phone, or automatically through a deployed app in the vehicle's GPS which instructs it to deploy at coordinate (x,y) and address road conditions in that area.

By way of example only, some actions based on the social feeds are as follows:

Validate that there is enough social response in a particular area regarding the same cause (e.g., Route 9N has accumulated snow in coordinate (x,y)).

Update system database with this information to serve as a historical data for future use.

Communicate the action item (e.g., deploy snow truck) to the trucks in the area and arrange which one will implement the action.

Communicate back to the social platform that action is taken care of, so that users are aware

Reset the request for this particular route.

Specifically, in the example shown in FIG. 4, passing vehicles (V1, V2, . . . , Vn) post feedback thru social media (e.g., mobile app, Facebook, etc.) about a particular sector/segment of road (see above). The social feed is compiled and passed thru a validation engine of the weather sentry system which analyzes the feed. Once the feed reaches a threshold, the weather sentry system updates its database with the data which will be used for future reference and to keep historical data.

The weather sentry system will also engage a notification engine which initiates communication with the deployed vehicles (e.g., snow removal trucks) passing the action request onto those deployed vehicles. Once the vehicle is engaged, and completes the job, it sends a confirmation back to the notification engine (of the weather sentry system). The notification engine updates the records, and communicate back to the social platform that the road is fixed.

FIG. 5 is a diagram illustrating exemplary road condition data collected (by the weather sentry system) from a vehicle. As provided above, this data may be collected from vehicles at periodic intervals. For illustrative purposes only, an interval of 30 minutes is being used in this example. The data reported from Car A (see FIG. 2) is shown in FIG. 5. Namely, as shown in FIG. 5, at 1200 hours (for a given location A) it is reported that the ABS system in the vehicle was engaged. The temperature data collected (by the vehicle's temperature sensors) indicates that the outside temperature at that time/location is freezing. Thus it may be deduced by the weather sentry system that there is a potential slippery road condition at that location due to ice/snow. As provided above, the weather sentry system will look to the data collected from other vehicles at that location to determine what action to take, if any. As provided above, the particular location(s) of interest can pertain to sectors/segments (also referred to herein as ‘stretches’ of road). Thus, based on the geo-coordinates of the vehicle at the time of reporting (obtained for example automatically from the vehicle's navigation system and/or provided by vehicle occupants), the particular stretch of road to which the reportings pertain can be easily determined. Thus, in the example provided in FIG. 5, the location field generically refers to given locations A, B, C, etc., which in this particular example refers to location A—i.e., a particular sector/segment of a road, B—i.e., another particular sector segment of a road, etc.

It is assumed that the vehicle is traveling (i.e., changing locations over time). Thus, based on the data shown in FIG. 5, in this example the vehicle is reporting that it is travelling away from areas of lower temperatures to areas of higher temperatures, transitioning from temperature above freezing to those below freezing. For instance, the vehicle might be traveling from a higher elevation with lower temperatures to a lower elevation with higher temperatures. Further, it shows that at 1500 hours, the vehicle (Car A in this example) reports that the ABS system was engaged, but that the temperature at that time, location was well above freezing. Based on this data, the weather sentry system might deduce that the ABS system was engaged for a reason other than slippery road conditions caused by ice/snow. It could also be reasoned that the vehicle's ABS or computer systems might be faulty or producing faulty readings, which might call into question the vehicles earlier reporting of an ABS engagement at 1200 hours. This is where comparison with data from other vehicles comes into play (e.g., either to confirm or deny the slippery road conditions at either location).

Turning now to FIG. 6, a block diagram is shown of an apparatus 600 for implementing one or more of the methodologies presented herein. By way of example only, apparatus 600 can be configured to implement one or more of the steps of methodology 300 for sharing road condition information.

Apparatus 600 comprises a computer system 610 and removable media 650. Computer system 610 comprises a processor device 620, a network interface 625, a memory 630, a media interface 635 and an optional display 640. Network interface 625 allows computer system 610 to connect to a network, while media interface 635 allows computer system 610 to interact with media, such as a hard drive or removable media 650.

As is known in the art, the methods and apparatus discussed herein may be distributed as an article of manufacture that itself comprises a machine-readable medium containing one or more programs which when executed implement embodiments of the present invention. For instance, when apparatus 600 is configured to implement one or more of the steps of methodology 300 the machine-readable medium may contain a program configured to collect data from vehicles related to road conditions at various locations; store the data in a off-vehicle system; process the data to determine what type of maintenance activity is needed based on the road conditions; and provide the maintenance activity and the locations to dispatchers to enable routing of municipal vehicles to the locations to address the road conditions.

The machine-readable medium may be a recordable medium (e.g., floppy disks, hard drive, optical disks such as removable media 650, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 620 can be configured to implement the methods, steps, and functions disclosed herein. The memory 630 could be distributed or local and the processor device 620 could be distributed or singular. The memory 630 could be implemented as an electrical, magnetic or optical memory, or any combination of these or other types of storage devices. Moreover, the term “memory” should be construed broadly enough to encompass any information able to be read from, or written to, an address in the addressable space accessed by processor device 620. With this definition, information on a network, accessible through network interface 625, is still within memory 630 because the processor device 620 can retrieve the information from the network. It should be noted that each distributed processor that makes up processor device 620 generally contains its own addressable memory space. It should also be noted that some or all of computer system 610 can be incorporated into an application-specific or general-use integrated circuit.

Optional display 640 is any type of display suitable for interacting with a human user of apparatus 600. Generally, display 640 is a computer monitor or other similar display.

The present techniques are further described by way of reference to the following non-limiting example. A vehicle (Car A) is travelling along a stretch of route 9 and encounters an icy road surface which causes the ABS system in Car A to activate. The weather sentry system is alerted of this ABS activation event, as well as the location and time of the event (as per one or more of the techniques described above). The passenger in Car A decides to use a mobile app via his/her smart phone which permits the passenger to tag this stretch of road and indicate that there are icy road conditions present. The mobile app will automatically send this data regarding this incident report (along with time and location data) to the weather sentry system. The weather sentry system will process all of this data from Car A and, as described above, will recommend correct actions for addressing the conditions on route 9. The road condition data and the correct action is stored in the weather sentry system database.

Say for instance that multiple vehicles also report data (in the same manner) regarding the icy conditions on route 9 exceeding a threshold number of reportings. Then the weather sentry system will send the coordinates of the icy road conditions on route 9 to snow removal/ice management trucks and (e.g., a regional dispatcher) can route/re-route trucks in the area to that location.

Once the icy condition has been addressed. The trucks and/or the regional manager can report back to the weather sentry system that the icy condition has been resolved. The weather sentry system will update its database to indicate that the icy road condition on route 9 no longer exists. The weather sentry system will also update the social media feeds to alert vehicles that the situation on route 9 has been resolved. Thus, vehicle occupants with access to the social site can (via their mobile app, social media application/portal, etc.) check in periodically to see what roads in their area are deemed to be incident free according to the weather sentry system's most recent feeds to the social media sites.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for sharing road condition information, the method comprising the steps of:
collecting data from vehicles related to road conditions at various locations;
storing the data in a off-vehicle system;
processing the data to determine what type of maintenance activity is needed based on the road conditions; and
providing the maintenance activity and the locations to dispatchers to enable routing of municipal vehicles to the locations to address the road conditions.

2. The method of claim 1, wherein the vehicles from which the data is collected comprise cars and other privately operated vehicles.

3. The method of claim 1, wherein the vehicles from which the data is collected comprise the municipal vehicles.

4. The method of claim 3, wherein the municipal vehicles comprise snow plows.

5. The method of claim 1, wherein the data collected from the vehicles comprises data collected by the vehicles themselves.

6. The method of claim 5, wherein the data is collected from the vehicles at predetermined time intervals.

7. The method of claim 1, wherein the data collected from the vehicles comprises data provided by occupants of the vehicles.

8. The method of claim 7, wherein the data is provided by the occupants of the vehicles via social media.

9. The method of claim 8, further comprising the step of:
posting to the social media once the road conditions have been addressed and resolved.

10. The method of claim 1, wherein the off-vehicle system comprises:
a validation engine configured to collect and process the data from the vehicles;
a database configured to store the data; and
a notification engine configured to provide the maintenance activity and the locations to the dispatchers.

11. An apparatus for sharing road condition information, the apparatus comprising:
a memory; and
at least one processor device, coupled to the memory, operative to:
collect data from vehicles related to road conditions at various locations;
store the data in a off-vehicle system;
process the data to determine what type of maintenance activity is needed based on the road conditions; and
provide the maintenance activity and the locations to dispatchers to enable routing of municipal vehicles to the locations to address the road conditions.

12. The apparatus of claim 11, wherein the vehicles from which the data is collected comprise cars and other privately operated vehicles.

13. The apparatus of claim 11, wherein the vehicles from which the data is collected comprise the municipal vehicles.

14. An article of manufacture for sharing road condition information, comprising a machine-readable recordable medium containing one or more programs which when executed implement the steps of:
collecting data from vehicles related to road conditions at various locations;
storing the data in a off-vehicle system;
processing the data to determine what type of maintenance activity is needed based on the road conditions; and
providing the maintenance activity and the locations to dispatchers to enable routing of municipal vehicles to the locations to address the road conditions.

15. The article of manufacture of claim 14, wherein the vehicles from which the data is collected comprise cars and other privately operated vehicles.

16. The article of manufacture of claim 14, wherein the vehicles from which the data is collected comprise the municipal vehicles.

17. A system for sharing road condition information, the system comprising:
a validation engine configured to i) collect data from vehicles related to road conditions at various locations and ii) process the data to determine what type of maintenance activity is needed based on the road conditions;
a database configured to store the data; and
a notification engine configured to provide the maintenance activity and the locations to dispatchers to enable routing of municipal vehicles to the locations to address the road conditions.

18. The system of claim 17, wherein the data collected from the vehicles comprises data provided by occupants of the vehicles.

19. The system of claim 18, wherein the data is provided by the occupants of the vehicles via social media.

20. The system of claim 19, wherein the notification engine is further configured to post to the social media once the road conditions have been addressed and resolved.
